(19) United States
(12) Patent Application Publication
(10) Pub. No.: US 2024/0382943 A1
(43) Pub. Date: Nov. 21, 2024

(54) HONEYCOMB BODY FOR A CATALYST FOR AN AFTERTREATMENT OF EXHAUST GAS, AND METHOD FOR PRODUCING SAME

(71) Applicant: Vitesco Technologies GmbH, Regensburg (DE)

(72) Inventors: Francois JAYAT, Wachtberg-Niederbachem (DE); Rolf BRÜCK, Bergisch Gladbach (DE)

(21) Appl. No.: 18/691,977

(22) PCT Filed: Sep. 19, 2022
(86) PCT No.: PCT/EP2022/075950

§ 371 Date: Mar. 14, 2024

(30) Foreign Application Priority Data
Sep. 27, 2021 (DE) 10 2021 210 776.1

(51) Int. Cl. B01J 35/57

(52) U.S. Cl. CPC B01J 35/57

(57) ABSTRACT

A honeycomb body for a catalyst for aftertreatment of exhaust gas of an internal combustion engine, formed of a plurality of metal foils, which are stacked one on top of the other to form a layer stack and wound about at least one point of rotation. At least some metal foils have an at least partial structuring, by which flow channels are formed between the individual layers, through which flow channels gas can flow in a main flow direction from a gas inlet side of the honeycomb body to a gas outlet side. The honeycomb body is formed of two sub-portions over which the flow channels extend substantially without interruption, the sub-portions are positioned at an angle of at least 45 degrees relative to one another.

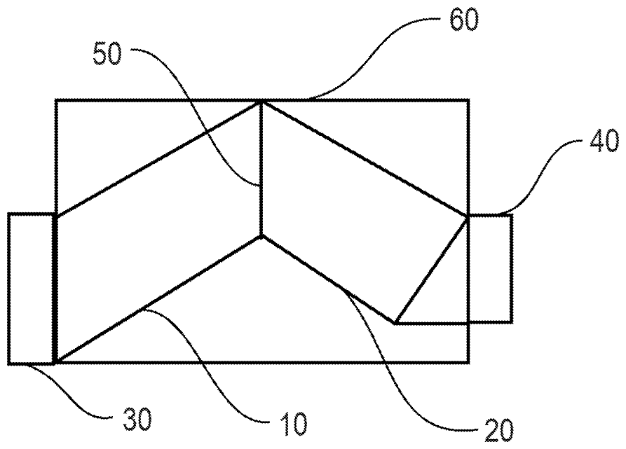

### CROSS REFERENCE TO RELATED APPLICATIONS

This is a U.S. national stage of Application No. PCT/EP2022/075950 filed Sep. 19, 2022. Priority is claimed on German Application No. DE 10 2021 210 776.1 filed Sep. 27, 2021, the content of which is incorporated herein by reference.

### BACKGROUND OF THE INVENTION

### 1. Field of the Invention

The disclosure relates to a honeycomb body for a catalyst for the purposes of aftertreatment of exhaust gas of an internal combustion engine, wherein the honeycomb body is formed of a plurality of metal foils which are stacked one on top of the other to form a layer stack and which are wound about at least one point of rotation, wherein at least some metal foils have an at least partial structuring, by which flow channels are formed between the individual layers, through which flow channels gas can flow in a main flow direction from a gas inlet side of the honeycomb body to a gas outlet side. The disclosure also relates to a method for producing a honeycomb body.

### 2. Description of the Related Art

Various exhaust gas catalysts are used for exhaust gas aftertreatment of internal combustion engines. Such catalysts have a plurality of channels through which gas can flow and which have a catalytically active surface. At a temperature that is specific for the particular catalyst in question, the exhaust gas flowing over the catalytically active surface is transformed by a chemical reaction and converted into products that are not harmful to the environment.

In the prior art, a large number of different exhaust gas catalysts are known, which each transform different constituents of the exhaust gas. The most common forms have either a ceramics honeycomb body or a metallic honeycomb body. The surfaces over which the gas flows are provided with coatings matched to their purpose, to allow the desired chemical reaction to take place.

In the case of metallic honeycomb bodies, the honeycomb body is formed by a plurality of metal foils, which are stacked one on top of the other to form a layer stack and are wound about at least one point of rotation. By using at least partially structured metal foils, cells are formed between the individual layers, said cells running in the axial direction of the honeycomb body from a gas inlet side to a gas outlet side, and the exhaust gas being able to flow through the cells.

The solutions from the prior art have the disadvantage that gas is able to flow through the honeycomb bodies of the catalysts substantially only linearly, and in particular a change of direction of the gas flow through a relatively large angle is not possible without the use of additional components, such as, for example, pipes or bends, which generally do not have catalytically active surfaces.

### SUMMARY OF THE INVENTION

Therefore, an object of one aspect of the present invention is a honeycomb body for use in a catalyst for the purposes of aftertreatment of exhaust gas of an internal combustion engine, which allows a change of direction of the main flow direction for an exhaust gas flowing through the honeycomb body and to provide a method for producing the honeycomb body.

One aspect of the invention relates to a honeycomb body for a catalyst for the purposes of aftertreatment of exhaust gas of an internal combustion engine, wherein the honeycomb body is formed of a plurality of metal foils which are stacked one on top of the other to form a layer stack and which are wound about at least one point of rotation, wherein at least some metal foils have an at least partial structuring, by which flow channels are formed between the individual layers, through which flow channels gas can flow in a main flow direction from a gas inlet side of the honeycomb body to a gas outlet side, wherein the honeycomb body is formed of two sub-portions over which the flow channels extend substantially without interruption, wherein the sub-portions are positioned at an angle of at least 10 degrees relative to one another.

The two sub-portions preferably have an identical number of flow channels, which likewise have an identical cross section. The sub-portions are positioned at an angle of at least 10 degrees, preferably of at least 45 degrees, relative to one another. The whole of the surface of the honeycomb body over which gas flows along the flow channels is provided with a catalytically active coating, so that the entire surface of the flow channels over which gas flows is catalytically active and participates in the chemical transformation of an exhaust gas flowing through the honeycomb body.

It is particularly advantageous for the honeycomb body to be of arcuate shape.

It is also advantageous for the two sub-portions to be produced by a cut through a honeycomb body with linearly extending flow channels.

The two sub-portions are preferably produced by cutting a conventional honeycomb body. In this manner, it can be ensured that the two sub-portions are identical in terms of the cell density and the channel geometry, and a profile of the flow channels which is seamless, preferably without interruption or at least substantially without interruption is ensured. Owing to the large number of individual flow channels and the manufacturing tolerances, it is to be expected that at least some of the flow channels are not wholly without interruption. In particular positional tolerances on joining play a part here; in addition, as a result of the connection, there may be an introduction of material into individual flow channels, as a result of which they can become partially or completely blocked.

A preferred exemplary embodiment is characterized in that the cut runs through the honeycomb body at an angle of 45 degrees to the center axis of the honeycomb body. The cut at an angle of 45 degrees to the center axis of the honeycomb body is particularly advantageous in order to obtain two sub-portions which can advantageously be placed one against the other and connected together. Wherein a modification of the flow direction of up to 90 degrees can be achieved.

It is also preferred that the two sub-portions are arranged rotated relative to one another through an angle at the interface. In particular in the case of a circular honeycomb body, the sub-portions produced by the cut can be arranged rotated relative to one another through any desired angle, as a result of which the flow channels are also each deflected by an angle resulting from the rotation. In the case where the sub-portions are rotated relative to one another through 180 degrees, a deflection of the flow channels through 90 degrees is obtained.

It is additionally advantageous for the two sub-portions to be connected together permanently and in a gas-tight manner. After the sub-portions of the honeycomb body have been cut, rotated and placed one against the other, they must be joined together again in a gas-tight manner and permanently. This can preferably be achieved by a soldering process. The sub-portions can also be inserted into a casing tube serving as a housing. For this purpose, the casing tube and the sub-portions can advantageously have positioning aids in order to ensure that the sub-portions are reliably arranged relative to one another at the desired predefined rotation angle. It can thus also be ensured that the flow channels of the sub-portions come into contact with one another in an aligned manner and as few flow channels as possible are blocked by being undesirably covered with structures of the respective other sub-portion.

It is further advantageous for the linear honeycomb body forming the two sub-portions to be formed rotationally symmetrically about its axially extending center axis. A rotationally symmetrical construction about the center axis ensures that the sub-portions, in particular when the sub-portions have been produced by a cut at an angle of 45 degrees to the center axis, can be arranged relative to one another at any rotational angle of from 0 degrees to 180 degrees without regions of the sub-portions protruding beyond the respective other sub-portion.

One aspect of the invention relates to a method for producing a honeycomb body, wherein a honeycomb body having linear flow channels which are arranged parallel to a central center axis extending in the axial direction is divided into two sub-portions by a cut at an angle to the center axis, wherein the two sub-portions are then brought together at the interface rotated relative to one another about the center axis through a rotation angle and are connected together permanently and in a gas-tight manner.

The production of the two sub-portions from a single honeycomb body is advantageous because it is thus ensured that the two sub-portions are identical to one another in terms of their cell density and channel geometry.

It is additionally advantageous for the two sub-portions to be produced by a cut at an angle of 45 degrees to the center axis of the honeycomb body. A cutting angle of 45 degrees is particularly advantageous because it permits infinite rotatability of the sub-portions relative to one another in the rotation angle range of from 0 degrees to 180 degrees.

### BRIEF DESCRIPTION OF THE DRAWINGS

The FIGURE is a schematic representation of a honeycomb body with two subportions.

### DETAILED DESCRIPTION OF THE PRESENTLY PREFERRED EMBODIMENTS

The FIGURE schematically shows a honeycomb body for a catalyst for the aftertreatment of exhaust gas of an internal combustion engine. The honeycomb body has flow channels are formed between the individual layers, through which flow channels gas can flow in a main flow direction from a gas inlet side 30 to a gas outlet side 40. The honeycomb body is formed of two sub-portions 10, 20 over which the flow channels extend substantially without interruption, wherein the sub-portions 10, 20 are positioned at an angle of at least 10 degrees relative to one another. As shown, the sub-portions are inserted into a casing tube 60, serving as a housing.

The two sub-portions 10, 20 are arranged rotated relative to one another through an angle at an interface 50. In particular in the case of a circular honeycomb body, the sub-portions 10, 20 produced by a cut (interface 50) and can be arranged rotated relative to one another through any desired angle, as a result of which the flow channels are also each deflected by an angle resulting from the rotation.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A honeycomb body for a catalyst for aftertreatment of exhaust gas of an internal combustion engine, comprising:
a first sub-portion and a second sub-portion each formed of a plurality of metal foils which are stacked on top of each other to form a layer stack which are wound about at least one point of rotation, wherein at least some metal foils have an at least partial structuring, by which flow channels are formed between respective layers, through which flow channels gas can flow in a main flow direction from a gas inlet side of the honeycomb body to a gas outlet side of the honeycomb body;
wherein the flow channels extend over the first sub-portion and the second sub-portion substantially without interruption, and
wherein the first sub-portion and the second sub-portion are positioned at an angle of at least 45 degrees relative to one another.

11. The honeycomb body as claimed in claim 10, wherein the honeycomb body is of arcuate shape.

12. The honeycomb body as claimed in claim 10, wherein the first sub-portion and the second sub-portion are produced by a cut through the honeycomb body with linearly extending flow channels.

13. The honeycomb body as claimed in claim 12, wherein the cut runs through the honeycomb body at an angle of 45 degrees to a center axis of the honeycomb body.

14. The honeycomb body as claimed in claim 12, wherein the first sub-portion and the second sub-portion are arranged rotated relative to one another through an angle at the cut, which forms an interface between the first sub-portion and the second sub-portion.

15. The honeycomb body as claimed in claim 12, wherein the first sub-portion and the second sub-portion are connected together permanently and in a gas-tight manner.

16. The honeycomb body as claimed in claim 12, wherein a linear honeycomb body forming the first sub-portion and the second sub-portion is formed rotationally symmetrically about its axially extending center axis.

17. A method for producing a honeycomb body, comprising:
stacking a plurality of metal foils on top of each other to form a layer stack;
winding the layer stack about at least one point of rotation,
wherein at least some metal foils have an at least partial structuring, by which flow channels are formed between respective individual layers, through which flow channels gas can flow in a main flow direction from a gas inlet side of the honeycomb body to a gas outlet side of the honeycomb body, the flow channels extend over a first sub-portion and a second sub-portion substantially without interruption;
producing the first sub-portion and the second sub-portion by a cut through the wound layer stack with linearly extending flow channels, the cut forming an interface between the first sub-portion and the second sub-portion;
wherein the linearly extending flow channels are arranged parallel to a central center axis extending in an axial direction is divided into the first sub-portion and the second sub-portion by the cut at an angle to a center axis;
bringing the first sub-portion and the second sub-portion together at the interface rotated relative to one another about the center axis through a rotation angle, wherein the first sub-portion and the second sub-portion are positioned at an angle relative to one another; and
connecting the first sub-portion and the second sub-portion together permanently in a gas-tight manner.

18. The method for producing a honeycomb body as claimed in claim 17, wherein the first sub-portion and the second sub-portion are produced by the cut at an angle of 45 degrees to the center axis of the honeycomb body.
